(19) United States
(12) Patent Application Publication
(10) Pub. No.: US 2019/0208068 A1
(43) Pub. Date: Jul. 4, 2019

(54) IMAGE FORMING APPARATUS, CONTROL METHOD IN IMAGE FORMING APPARATUS AND STORAGE MEDIUM

(71) Applicant: CANON KABUSHIKI KAISHA, Tokyo (JP)

(72) Inventor: Fumiaki Hirose, Saitama-shi (JP)

(21) Appl. No.: 16/229,079

(22) Filed: Dec. 21, 2018

(30) Foreign Application Priority Data
Dec. 28, 2017 (JP) 2017-254098

(51) Int. Cl. H04N 1/00

(52) U.S. Cl. CPC H04N 1/00652; H04N 1/00602; H04N 1/00962; H04N 1/00933

(57) ABSTRACT

It is possible to more securely reduce the printing time of printing processing to perform printing while conveying printing sheets in an overlapping manner. An image forming apparatus capable of conveying printing sheets in an overlapping manner to a printing unit, and including: an application unit configured to apply a print setting to an image; a setting unit configured to set an overlap amount of one printing sheet and another printing sheet conveyed in a state of overlapping part of the one printing sheet based on the print setting; and a conveyance unit configured to convey the one printing sheet on which an image after the print setting is applied by the application unit is printed and the other printing sheet in an overlapping manner in accordance with the overlap amount set by the setting unit.

### BACKGROUND OF THE INVENTION

### Field of the Invention

The present invention relates to an image forming apparatus capable of conveying printing sheets in an overlapping manner.

### Description of the Related Art

In performing printing for a plurality of printing sheets in an image forming apparatus, in a case where printing sheets are conveyed one by one with an interval therebetween, the printing time lengthens accordingly. Consequently, a technique has been proposed that reduces the printing time by reducing the interval. Further, a technique has also been proposed that further reduces the printing time by conveying a subsequent printing sheet (hereinafter, called a subsequent sheet) of a preceding printing sheet (hereinafter, called a preceding sheet) with part of the subsequent sheet overlapping the preceding sheet (see Japanese Patent Laid-Open No. 2016-165833).

As described in Japanese Patent Laid-Open No. 2016-165833, in a case where printing sheets are conveyed in an overlapping manner, it is necessary to determine a non-print area where printing is not performed by analyzing print-target images in order to determine an amount (length in the conveyance direction) by which the preceding sheet and the subsequent sheet overlap. Hereinafter, the amount by which the preceding sheet and the subsequent sheet overlap is called a sheet overlap amount or simply an overlap amount.

However, there is a case where the image analysis for determining a non-print area takes time depending on a print-target image. In such a case, even though the conveyance time can be reduced, it is no longer possible to sufficiently reduce the time taken for the entire printing processing. Consequently, in order to reduce the printing time in the printing processing to perform printing while conveying printing sheets in an overlapping manner, it is necessary to efficiently perform the determination of a non-print area.

Consequently, an object of the present invention is to provide an image forming apparatus capable of more securely reducing the printing time of printing processing to perform printing while conveying printing sheets in an overlapping manner.

### SUMMARY OF THE INVENTION

The image forming apparatus according to the present invention is an image forming apparatus capable of conveying printing sheets in an overlapping manner to a printing unit, the image forming apparatus including: an application unit configured to apply a print setting to an image; a setting unit configured to set an overlap amount of one printing sheet and another printing sheet conveyed in a state of overlapping part of the one printing sheet based on the print setting; and a conveyance unit configured to convey the one printing sheet on which an image after the print setting is applied by the application unit is printed and the other printing sheet in an overlapping manner in accordance with the overlap amount set by the setting unit.

Further features of the present invention will become apparent from the following description of exemplary embodiments with reference to the attached drawings.

### BRIEF DESCRIPTION OF THE DRAWINGS

FIG. 1 is a block diagram showing an example of a configuration of an image forming apparatus according to a first embodiment;

FIG. 2 is an external appearance diagram of an MFP;

FIG. 3A to FIG. 3D are diagrams for explaining an internal configuration of an image forming unit and sheet overlap control in the image forming unit;

FIG. 4A to FIG. 4H are diagrams for explaining a specification method of a non-print area in a control unit according to the first embodiment;

FIG. 5 is a diagram showing the relationship of FIG. 5A and FIG. 5B;

FIG. 5A and FIG. 5B are flowcharts showing non-print area derivation processing for the control unit to specify a non-print area according to the first embodiment;

FIG. 6A and FIG. 6B are diagrams showing the way a preceding sheet and a subsequent sheet are conveyed in an overlapping manner; and

FIG. 7 is a diagram showing an example of a sequence in a case where a print job is input to the MFP.

### DESCRIPTION OF THE EMBODIMENTS

In the following, embodiments of the present invention are explained by using the drawings. The following embodiments are not intended to limit the present invention according to the scope of the claims and all combinations of features explained in the present embodiments are not necessarily indispensable to the solution of the present invention.

### First Embodiment

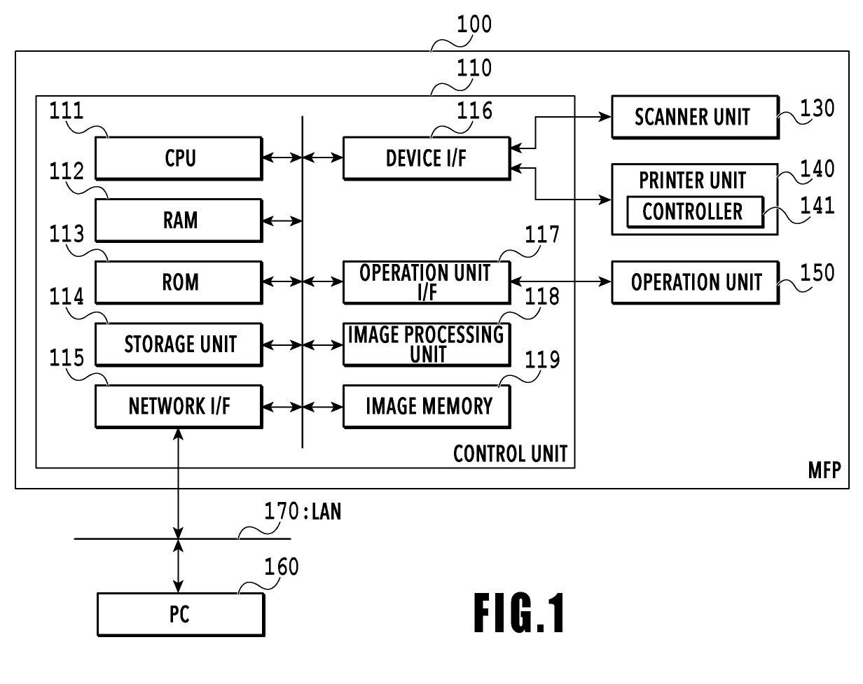

FIG. 1 is a block diagram showing an example of a configuration of an MFP (Multi Function Peripheral) used as an image forming apparatus according to a first embodiment. An MFP 100 includes a control unit (also called a control apparatus) 110, a scanner unit 130, a printer unit 140, and an operation unit 150. The control unit 110 has a CPU 111, a RAM 112, and a ROM 113. Further, the control unit 110 has a storage unit 114, a network I/F (InterFace) 115, a device I/F 116, an operation unit I/F 117, an image processing unit 118, and an image memory 119. The printer unit 140 has a controller 141.

The control unit 110 is connected with the scanner unit 130, which is an image input device, and the printer unit 140, which is an image output device, and controls input and output of image information. Further, the control unit 110 is connected to a LAN (Local Area Network) and performs reception and the like of a print job including PDL (Page Description Language) data via the LAN. The CPU 111 controls the operation of the MFP 100 and operates based on programs stored in the RAM 112. The ROM 113 is a boot ROM and in which a boot program of the system is stored. The storage device 114 is a storage device, such as an HDD (Hard Disk Drive), and in which system software, image data, programs for controlling the operation of the MFP 100, and so on are stored. The program stored in the storage unit 114 is loaded onto the RAM 112. The CPU 111 controls the operation of the MFP 100 based on the program loaded onto the RAM 112. The network I/F 115 is connected to the LAN and performs communication with an external device, such as a PC (Personal Computer) 160, via a network and governs input and output of various kinds of information. The device I/F 116 connects the scanner unit 130, which is an image input device, and the printer unit 140, which is an image output device, with the control unit 110 and performs synchronous system/asynchronous system conversion of image data. The operation unit I/F 117 is an interface that connects the operation unit 150 and the control unit 110 and outputs image data that is displayed on the operation unit 150 to the operation unit 150. Further, the operation unit I/F 117 transmits information input by a user from the operation unit 150 to the CPU 111. The operation unit 150 is a user interface unit having an input/output unit configured to input and output various kinds of information. It may also be possible for the operation unit 150 to have a user interface unit having a display unit and in which the display unit and the input/output unit are integrated into one unit. The image processing unit 118 performs image processing for image data received via the LAN, performs image processing for image data input and output from the device I/F 116, and so on. The image memory 119 is a memory for temporarily loading image data to be processed by the image processing unit 118.

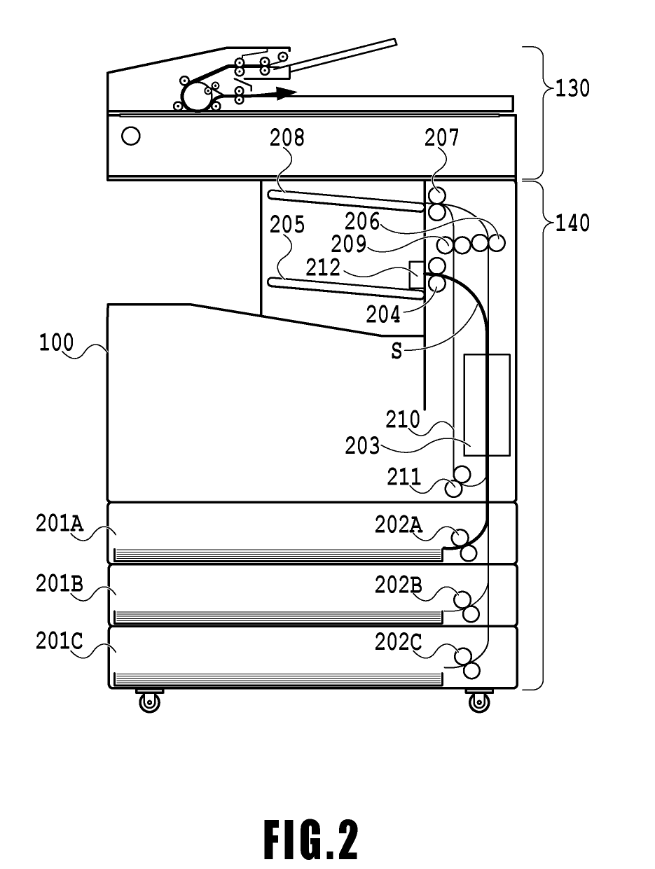

FIG. 2 is an external appearance diagram of the MFP 100. In the MFP 100, the scanner unit 130 is arranged on the top of the printer unit 140. The printer unit 140 includes sheet feed units 201 (201A, 201B, 201C) storing printing sheets, conveyance rollers 202 (202A, 202B, 202C) corresponding to the respective sheet feed units, and an image forming unit 203. Further, the printer unit 140 includes a conveyance roller 204, a discharged sheet tray 205, feed rollers 206 and 207, a discharged sheet tray 208, a feed roller 209, a double-sided printing conveyance path 210, a conveyance roller 211, and a stapling device 212. These components are controlled by the controller 141. In FIG. 2, the three sheet feed units are illustrated, but the printer unit 140 may include any number of sheet feed units.

The conveyance roller 202 feeds a printing sheet S stored in the sheet feed unit 201 to the image forming unit 203. At this time, in a case where a sheet overlap amount is set, as will be described later, at timing at which part of a subsequent printing sheet overlaps a preceding printing sheet, the subsequent printing sheet is fed. Due to this, the preceding printing sheet and the subsequent printing sheet are conveyed to the image forming unit 203 in the state where part of the subsequent printing sheet overlaps the preceding printing sheet. The image forming unit 203 forms (prints) an image on the printing sheet S that is fed. The image forming unit 203 may adopt the ink jet method that prints an image by spraying ink onto a printing sheet or the electrophotographic method that prints an image by fixing toner onto a printing sheet. In FIG. 2, the image forming unit 203 is installed vertically (so that the conveyance direction is the vertical direction), but the image forming unit 203 may be installed not vertically. For example, the image forming unit 203 may be installed horizontally (so that the conveyance direction is the horizontal direction). The printing sheet S on which an image is printed by the image forming unit 203 is discharged onto the discharged sheet tray 205 through the conveyance roller 204. In a case where double-sided printing is specified, the printing sheet is once sent to the discharged sheet tray 208 via the feed rollers 206 and 207, not via the conveyance roller 204. The printing sheet sent to the discharged sheet tray 208 is sent to the double-sided printing conveyance path 210 by the feed roller 207 and the feed roller 209 that rotate in the opposite direction. The printing sheet sent to the double-sided printing conveyance path 210 is conveyed again to the image forming unit 203 by the conveyance roller 211 provided on the upstream side of the double-sided printing conveyance path 210. The stapling device 212 staples printing sheets output onto the discharged sheet tray 205.

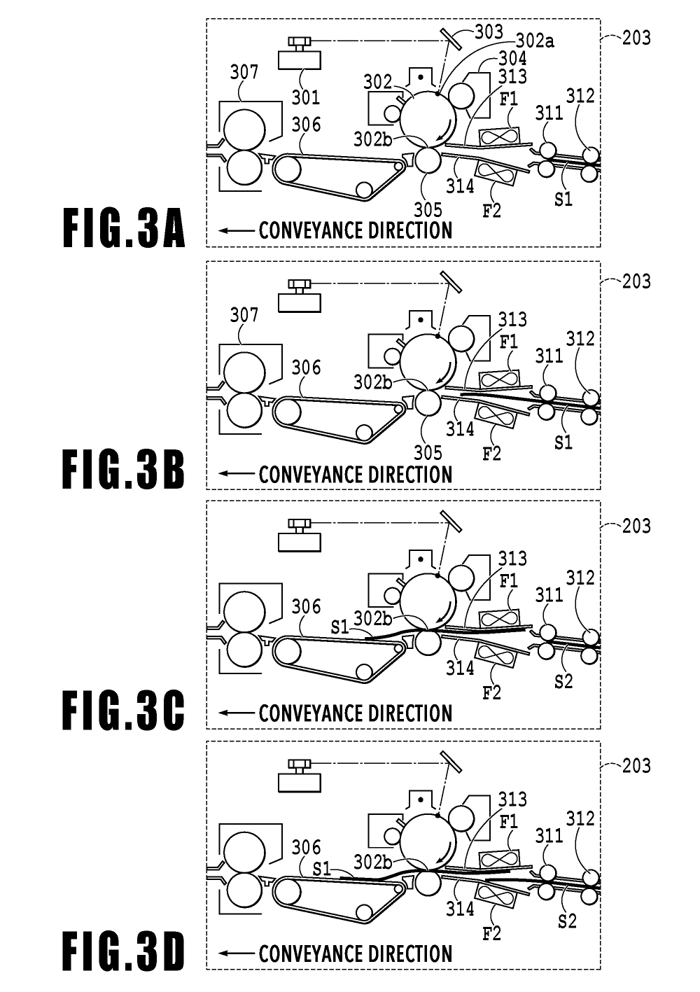

FIG. 3A to FIG. 3D are diagrams for explaining the internal configuration of the image forming unit 203 and the sheet overlap control in the image forming unit 203. Here, the electrophotographic image forming unit installed horizontally (so that the conveyance direction is the horizontal direction) within the MFP 100 is taken as an example. In FIG. 3A to FIG. 3D, the leftward direction (leftward direction in a case of facing the drawing) is the conveyance direction (sub scanning direction).

As shown in FIG. 3A to FIG. 3D, the image forming unit 203 has a laser scanner 301, a photoconductor drum 302, which is an image carrier, a mirror 303, a development counter 304, a transfer electrifier 305, a conveyance belt 306, and a fixing device 307. Then, at the time of image formation, first, a laser ray output from the laser scanner 301 is reflected from the mirror 303 and an exposure position 302a on the photoconductor drum 302 rotating in the clockwise direction (direction indicated by arrows in FIG. 3A to FIG. 3D) is irradiated with the laser ray. Due to this, a latent image is formed on the photoconductor drum 302. The latent image thus formed on the photoconductor drum 302 is visualized as a toner image by the development counter 304. Next, the visualized toner image on the photoconductor drum 302 is transferred onto a printing sheet by the transfer electrifier 305 at a transfer section 302b. Further, the printing sheet onto which the toner image is transferred is conveyed to the fixing device 307 by the conveyance belt 306 and the transferred image is permanently fixed in the fixing device 307. Then, the printing sheet is discharged onto the discharged sheet tray 205 from the fixing device 307 through the conveyance roller 204. In a case where double-sided printing is specified, the printing sheet is discharged onto the discharged sheet tray 208 from the fixing device 307 through the feed rollers 206 and 207.

It is possible for the image forming unit 203 in the present embodiment to convey a preceding sheet in a state of being overlapped by part of a subsequent sheet to the transfer section 302b. Further, the image forming unit 203 has suction fans F1 and F2 and it is possible to switch an overlapping state of a preceding sheet and a subsequent sheet to another state by the controller 141 controlling the suction fans F1 and F2. The suction fans F 1 and F2 are provided on conveyance guides 313 and 314 arranged in opposition to each other between a resisting roller 311 and the transfer section 302b as shown in FIG. 3A to FIG. 3D. Further, it is possible for the suction fans F1 and F2 to control generation of a suction force by switching between on and off. As will be described later, the controller 141 drives one of the upper side suction fan F1 and the lower side suction fan F2 (in the present embodiment, the upper side suction fan F 1) based on information indicating the overlap amount (sheet overlap amount information) transmitted from the control unit 110. Further, the controller 141 controls a resisting roller motor (not shown schematically) so as to change the sheet conveyance speed by the resisting roller 311. In this manner, the sheet overlap control is performed.

Here, the sheet overlap control by the controller 141 is explained in detail. First, the controller 141 controls the conveyance rollers 202A, 202B, and 202C and sends out a printing sheet S1 (hereinafter, described as sheet S1) from one of the sheet feed units 201A, 201B, and 201C. Then, the controller 141 sends the sheet S1 into the resisting roller 311 at rest by a pre-resisting roller 312. Due to this, as shown in FIG. 3A, the front end of the sheet S1 hits the resisting roller 311. Next, the controller 141 corrects the front end position and skew of the sheet S1 by suspending the rotation of the pre-resisting roller 312 after sending the sheet S1 by a predetermined amount by the pre-resisting roller 312. After correcting the front end position and skew, the controller 141 rotates the resisting roller 311 and sends the sheet S1 toward the transfer section 302b as shown in FIG. 3B. Then, the controller 141 turns on the upper side suction fan F 1 at the time of the rear end portion of the sheet S1 (upstream side end portion in the sheet conveyance direction) being about to exit the resisting roller 311. Due to this, the rear end portion of the sheet S1 is sucked to the lower side surface of the conveyance guide 313 and adheres close to the lower side surface of the conveyance guide 313 as shown in FIG. 3C. Next, the controller 141 conveys the sheet S1 in a state where the rear end portion of the sheet S1 is caused to adhere close to the lower side surface of the conveyance guide 313. Further, at the same time, the controller 141 sends out a subsequent printing sheet S2 (hereinafter, described as sheet S2) from the resisting roller 311 at a speed higher than the sheet conveyance speed of the sheet S1. Due to this, as shown in FIG. 3D, the front end portion of the subsequent sheet S2 comes under the rear end portion of the preceding sheet S1.

In a case where the front end portion of the subsequent sheet S2 comes under the rear end portion of the preceding sheet S1 as described above, the controller 141 reduces the sheet conveyance speed of the resisting roller 311 to the same speed as the sheet conveyance speed of the preceding sheet S1 as well as turning off the suction fan F1. Due to this, the preceding sheet S1 and the subsequent sheet S2 are conveyed toward the transfer section 302b at the same sheet conveyance speed in a state where the rear end portion of the preceding sheet S1 overlaps the front end portion of the subsequent sheet S2 from above by a predetermined amount. By the process such as this, it is made possible to convey the preceding sheet S1 and the subsequent sheet S2 in a state where the rear end portion of the preceding sheet S1 overlaps the front end portion of the subsequent sheet S2. In the above-described example, the case is explained where the front end portion of the subsequent sheet S2 is caused to overlap the rear end portion of the preceding sheet S1 from under by operating the upper side suction fan F1. However, it may also be possible to cause the front end portion of the subsequent sheet S2 to overlap the rear end portion of the preceding sheet S1 from above by operating the lower side suction fan F2 similarly. Further, it may also be possible to selectively operate the suction fans F1 and F2 so that an overlapping state of printing sheets continuously conveyed can be selected arbitrarily. Here, it is possible to arbitrarily set the overlap amount of the sheets S1 and S2 by changing the period of time of the increased speed as well as increasing the sheet conveyance speed of the resisting roller 311 by changing the rotation speed of the resisting roller motor after the preceding sheet passes.

In the present embodiment, as will be described later, the control unit 110 specifies the size (length in the sub scanning direction) of a non-print area at the end portion in the sub scanning direction of a printing sheet from the print setting specified in the print job. Then, the control unit 110 transmits the information indicating the specified size of the non-print area (non-print area information) to the printer unit 140. Then, the controller 141 of the printer unit 140 drives the overlap amount of the sheets S1 and S2 based on the received non-print area information and performs the sheet overlap control as described above based on the derived overlap amount.

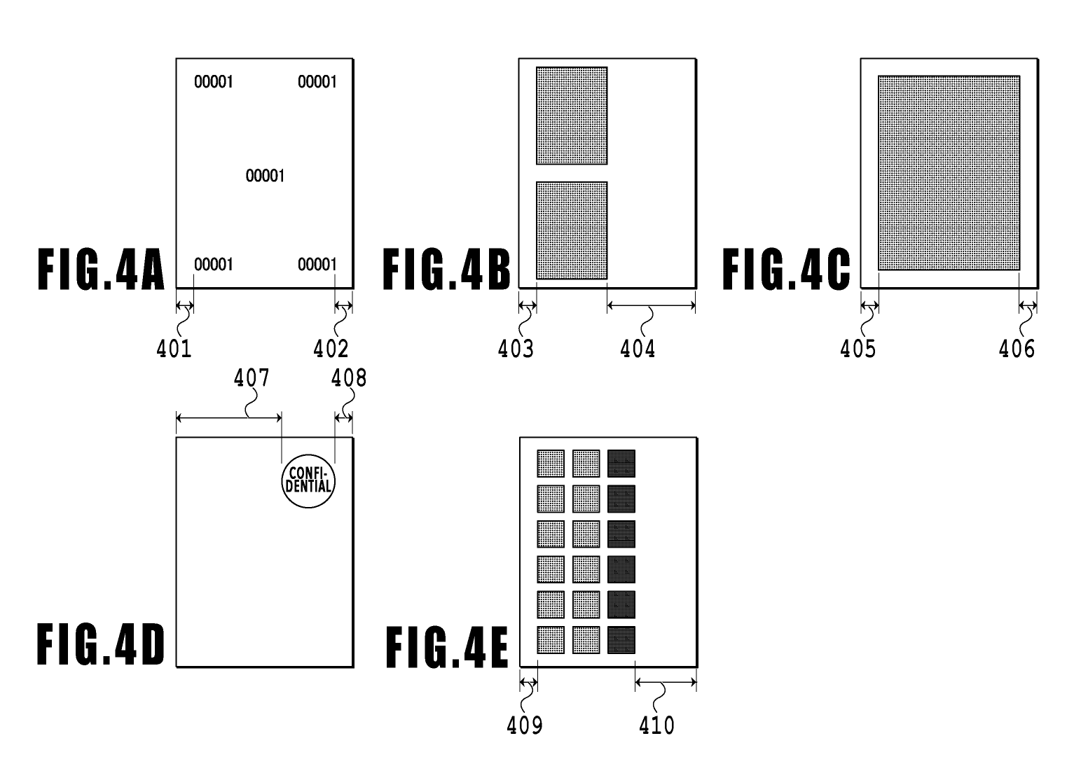

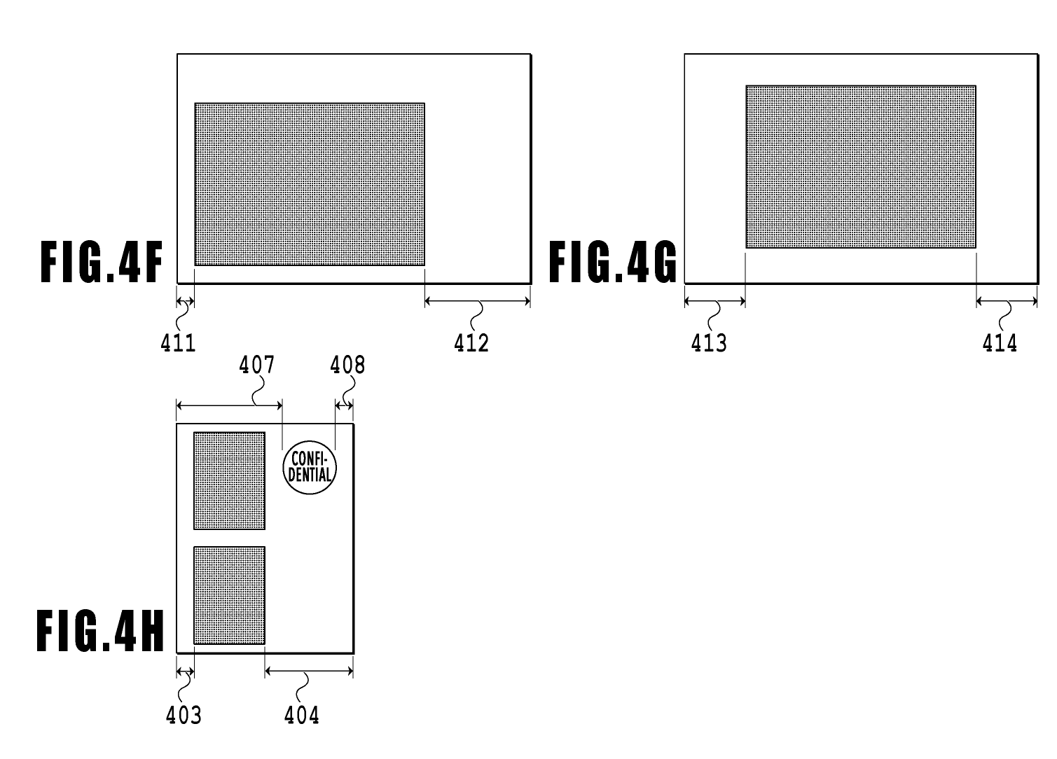

FIG. 4A to FIG. 4H are diagrams for explaining the specification method of a non-print area in the control unit 110 according to the first embodiment. In FIG. 4A to FIG. 4H, output materials (printing sheets) on which images are printed are shown schematically. It is assumed that each printing sheet is conveyed in the leftward (leftward direction in FIG. 4A to FIG. 4H). That is, in FIG. 4A to FIG. 4H, the left side in a case of facing FIG. 4A to FIG. 4H is the front end of the printing sheet and the right side is the rear end.

In FIG. 4A, an output material for which a copy number print setting is set is shown schematically. The copy number print function is a function to print the number of the copy of the specified number of output copies on a printing sheet. In a case where this function is set, figures are printed on the entire sheet surface as shown in FIG. 4A, and therefore, the areas indicated by bidirectional arrows 401 and 402 are specified as a non-print area. As the function to perform printing on the entire printing sheet surface such as this, there is a background pattern print function or the like, in addition to the copy number print function.

In FIG. 4B, an output material for which a reduction layout (N in 1) setting is set is shown schematically. The reduction layout function is a function to reduce document images of a plurality of pages, arrange all the reduced document images together on one printing sheet, and produce an output. FIG. 4B shows an example of an output material in a case where there are document images of only the two pages in the 4 in 1 setting in which all the document images of the four pages are printed together on one printing sheet. In a case where this function is set, as shown in FIG. 4B, the areas indicated by bidirectional arrows 403 and 404 are specified as a non-print area.

In FIG. 4C, an output material for which a frame deletion setting is set is shown schematically. The frame deletion function is a function to produce an output by providing a margin in an amount specified in advance at the time of printing an image on a printing sheet. It is possible to specify an amount of margin independently at any position of the front end (downstream side end portion in the conveyance direction), the rear end (upstream side end portion in the conveyance direction), the left end, and the right end of the printing sheet. Setting a certain area as a margin means that printing is not performed in that area. Consequently, in a case where this function is set, as shown in FIG. 4C, the areas indicated by bidirectional arrows 405 and 406 (margins at the front end and the rear end of the printing sheet) are specified as a non-print area.

In FIG. 4D, an output material for which a stamp setting is set is shown schematically. The stamp function is a function to perform printing by combining a pattern prepared in advance with a document image. In a case where this function is set, the non-print area is specified by a pattern. As shown in FIG. 4D, in a case where “confidential” is combined as a pattern, the areas indicated by bidirectional arrows 407 and 408 are specified as a non-print area. As the function to combine a pattern such as this, there is a function to attach a two-dimensional barcode to a document image or the like, in addition to the stamp function.

In FIG. 4E, an output material on which a specific pattern is printed is shown schematically. The specific pattern is, for example, a test chart. The function to print a specific pattern is programmed in advance including also the size of an image to be printed. Because of this, at the time of printing a specific pattern, it is possible to specify the areas indicated by bidirectional arrows 409 and 410 as a non-print area without the need to analyze the image.

In FIG. 4F and FIG. 4G an output material that is output in a case where the size of the printing sheet is larger than the size of the document image is shown schematically. As shown in FIG. 4F, in a case where the document image is arranged on the front end side of the printing sheet (on the left side in FIG. 4F), no document image is printed in the areas indicated by bidirectional arrows 411 and 412, and therefore, the areas are specified as a non-print area. Further, in a case where the document image is arranged at the center of the printing sheet, no document image is printed in the areas indicated by bidirectional arrows 413 and 414, and therefore, the areas are specified as a non-print area.

As explained above, it is possible to specify a non-print area by a print setting specified in a print job. Further, it is possible to set each setting shown in FIG. 4A to FIG. 4G in a duplicated manner. Here, an example of the specification method of a non-print area in a case where a plurality of settings is set in a duplicated manner is explained by using FIG. 4H.

In FIG. 4H, an output material that is output in a case where the reduction layout setting shown in FIG. 4B and the stamp setting shown in FIG. 4D are set at the same time is shown schematically. At this time, as the non-print areas on the front end side, the area indicated by the bidirectional arrow 403 is specified from the reduction layout setting and the area indicated by the bidirectional arrow 407 is specified from the stamp setting. Then, the control unit 110 selects a smaller area from the specified non-print areas. Consequently, in the example shown in FIG. 4H, the non-print area on the front end side is determined to be the area indicated by the bidirectional arrow 403. Similarly, the non-print area on the rear end side is determined to be the area indicated by the bidirectional arrow 408.

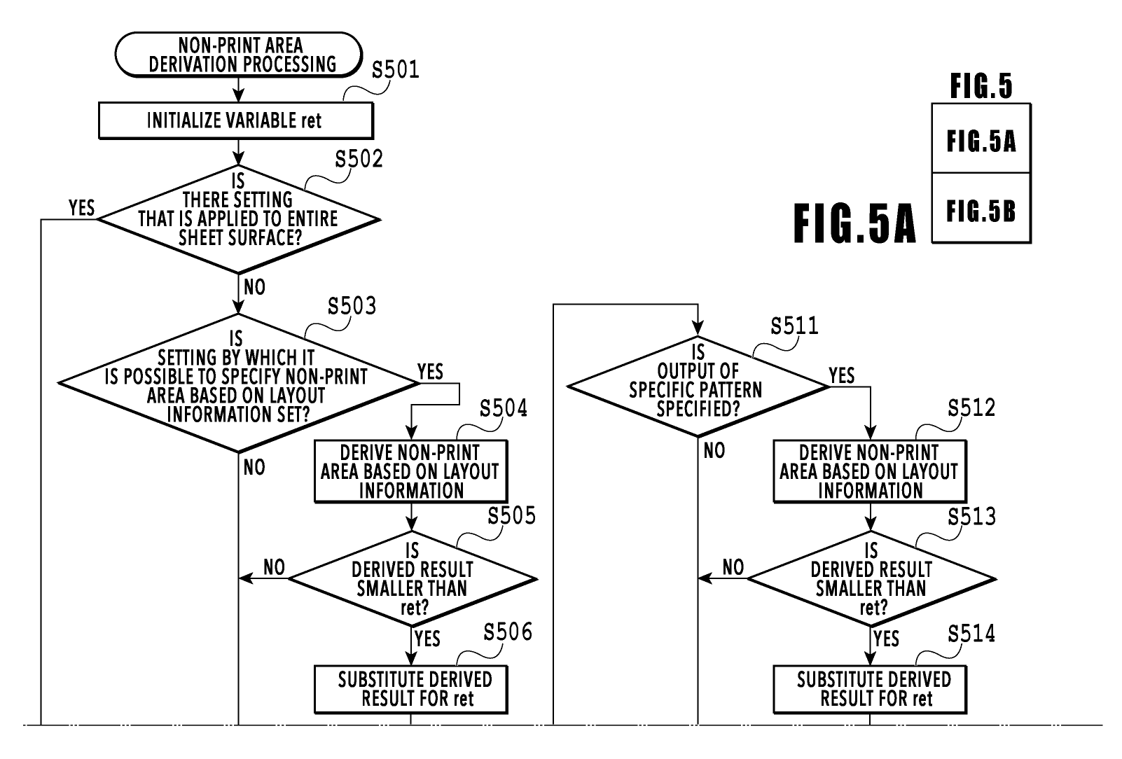

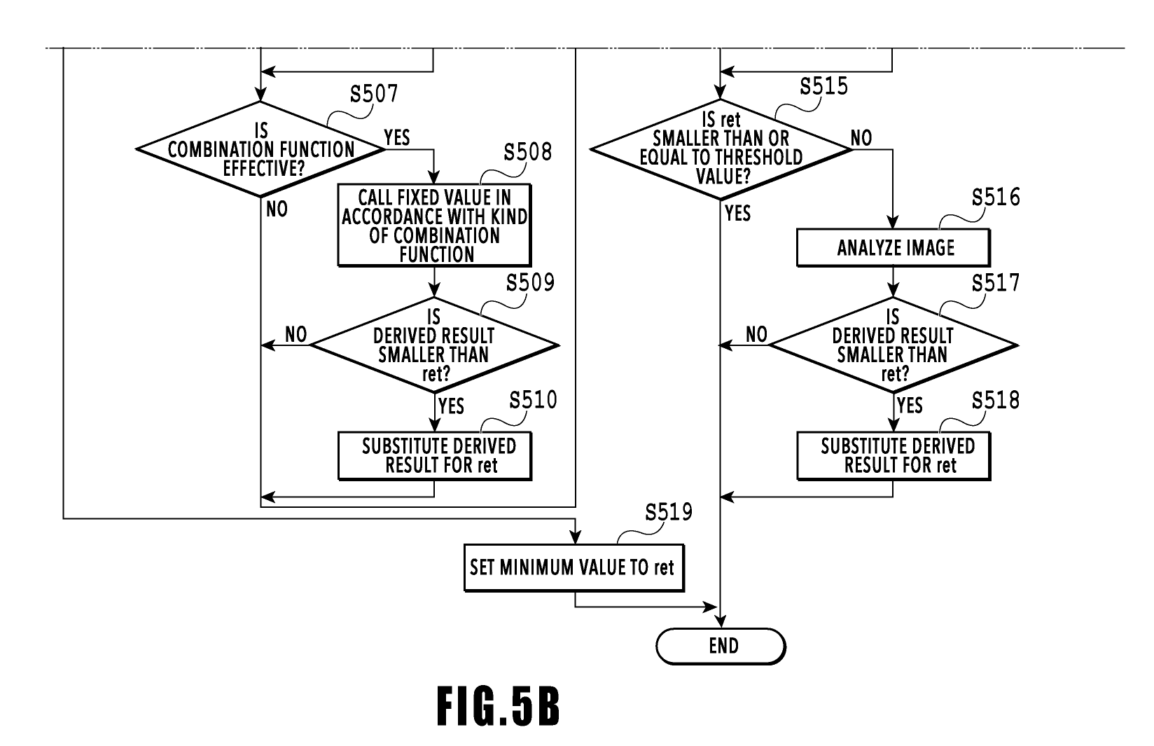

FIG. 5A and FIG. 5B are flowcharts showing non-print area derivation processing for the control unit 110 to specify a non-print area according to the first embodiment. The processing shown in FIG. 5A and FIG. 5B is performed by, for example, a program stored in the storage unit 114 being loaded onto the RAM 112 and being executed by the CPU 111.

First, the control unit 110 initializes a variable ret by the sheet size (step S501). The variable ret is a variable indicating the size of a non-print area. The variable ret is the sheet size means that the printing sheet to be output is a sheet whose entire surface is white. Next, the control unit 110 determines whether there is a setting that is applied to the entire sheet surface (step S502). For example, in a case where a setting that makes effective the copy number print function shown in FIG. 4A is included in a print job, it is determined that there is a setting that is applied to the entire sheet surface. In a case where there is a setting that is applied to the entire sheet surface (YES at step S502), the control unit 110 sets the minimum value to the variable ret and terminates the processing (step S519). Here, as the minimum value, an initial margin value of the printer unit 140 is used. In a case where there is not a setting that is applied to the entire sheet surface (NO at step S502), the control unit 110 determines whether a setting by which it is possible to specify a non-print area based on image layout information is set (step S503). The image layout information referred to here is a general term of information indicating in which arrangement the document image is output finally. In the present embodiment, the image layout information refers to the information relating to each function shown in FIG. 4B, FIG. 4C, FIG. 4F, and FIG. 4G In a case of a setting by which it is possible to specify a non-print area (YES at step S503), the control unit 110 derives the size (length in the sub scanning direction) of the non-print area based on the image layout information (step S504). Then, the control unit 110 determines whether the derived result is smaller than the value of the variable ret at that point in time (step S505). In a case where the derived result is smaller than the value of the variable ret (YES at step S505), the control unit 110 substitutes the derived result for the variable ret (step S506) and advances to step S507. In a case where the derived result is larger than or equal to the value of the variable ret (NO at step S505), the control unit advances to step S507 without performing anything.

Next, the control unit 110 determines whether the combination function is effective (step S507). For example, in a case where a setting that makes effective the stamp function shown in FIG. 4D or the function to attach a two-dimensional barcode is included in the print job, it is determined that the combination function is effective. In a case where the combination function is effective (YES at step S507), the control unit 110 calls a fixed value in accordance with the kind of combination function (step S508). Then, the control unit 110 determines whether the called fixed value is smaller than the value of the variable ret at that point in time (step S509). In a case where the fixed value is smaller than the value of the variable ret (YES at step S509), the control unit 110 substitutes the fixed value for the variable ret (step S510) and advances to step S511. In a case where the fixed value is larger than or equal to the value of the variable ret (NO at step S509), the control unit 110 advances to step S511 without performing anything.

Next, the control unit 110 determines whether the output of a specific pattern is specified (step S511). For example, in a case where the setting that makes effective the function to print the specific pattern shown in FIG. 4E is included in the print job, it is determined that the output of a specific pattern is specified. In a case where the output of the specific pattern is specified (YES at step S511), the control unit 110 calls a fixed value in accordance with the specific pattern (step S512). Then, the control unit 110 determines whether the called fixed value is smaller than the value of the variable ret at that point in time (step S513). In a case where the fixed value is smaller than the value of the variable ret (YES at step S513), the control unit 110 substitutes the fixed value for the variable ret (step S514) and advances to step S515. In a case where the fixed value is larger than or equal to the value of the variable ret (NO at step S513), the control unit 110 advances to step S515 without performing anything.

Next, the control unit 110 determines whether the value of the variable ret at the current point in time is smaller than or equal to a threshold value determined in advance (step S515). This processing is for determining whether it is necessary to analyze an output-target image in order to determine a final non-print area. That is, in a case where the value (ret) of the non-print area derived in the process up to step S515 is sufficiently small, it is determined that the output-target image does not need to be analyzed. As the threshold value used for the determination at step S515, the initial margin value of the printer unit 140 is used.

In a case where the value of the variable ret is larger than the threshold value (NO at step S515), the control unit 110 analyzes the output-target image (step S516). Then, the control unit 110 determines whether the analysis result (size of the non-print area) obtained by analyzing the image is smaller than the value of the variable ret at that point in time (step S517). In a case where the analysis result is smaller than the value of the variable ret (YES at step S517), the control unit 110 substitutes the analysis result for the variable ret (step S518) and terminates the processing. In a case where the analysis result is larger than or equal to the value of the variable ret (NO at step S517), the control unit 110 terminates the processing without performing anything.

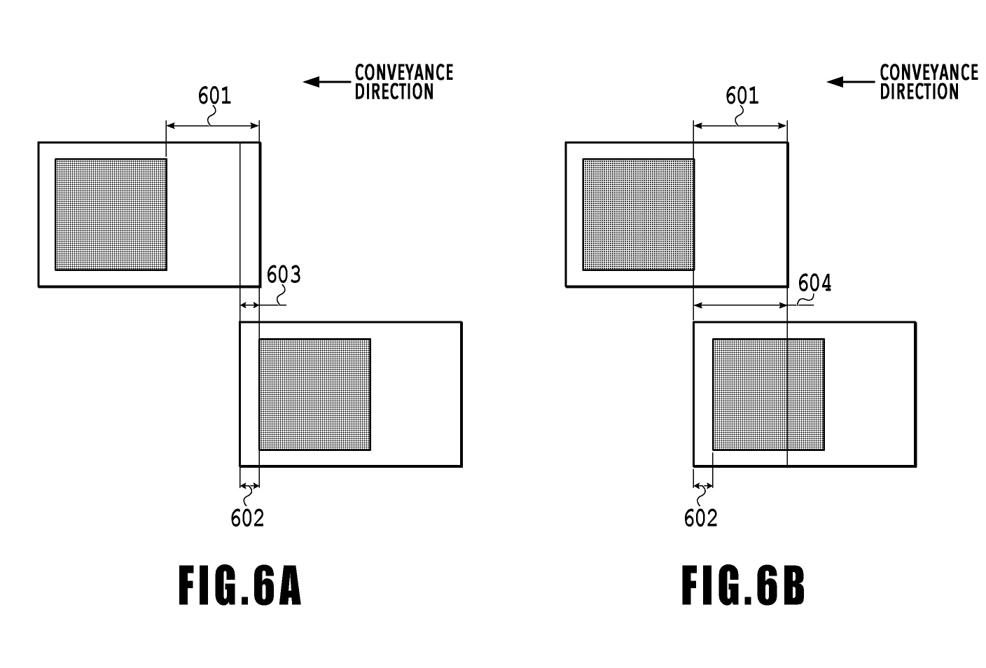

In the present embodiment, the processing at steps S501 to S519 described above is performed for the front end side and the rear end side of the printing sheet, respectively. That is, the sizes (for example, the numbers of lines in the conveyance direction) of the non-print areas on the front end side and the rear end side of the printing sheet are derived and each of the derived values is delivered to the printer unit 140. Then, the printer unit 140 adopts one of the size of the non-print area on the rear end side in the preceding sheet and the size of the non-print area on the front end side in the subsequent sheet, which is smaller, as the overlap amount at the time of conveying each printing sheet so that another printing sheet does not overlap the print area of each printing sheet. The reason is that in a case where another printing sheet overlaps a print area at the time of the fixing device 307 fixing a transferred image onto the print area of a printing sheet, there is a possibility that fixing of the transferred image is not performed appropriately in the fixing device 307. It is also possible to appropriately fix a transferred image by controlling the fixing temperature, but there is a possibility that the processing becomes complicated. Consequently, in the present embodiment, the number of overlapped sheets in the print area is made to be one by preventing another printing sheet from overlapping the print area of each printing sheet. FIG. 6A and FIG. 6B are diagrams showing the way a preceding sheet and a subsequent sheet are conveyed in an overlapping manner. In FIG. 6A and FIG. 6B, an example of a case is shown where a non-print area 602 on the front end side in the subsequent sheet is smaller than a non-print area 601 on the rear end side in the preceding sheet. As shown in FIG. 6A, by overlapping both the printing sheets in accordance with the smaller non-print area 602, it is made possible to prevent the print area from being included in an overlap area 603. On the other hand, as shown in FIG. 6B, in a case where both sheets are overlapped in accordance with the larger non-print area 601, the print area is included in an overlap area 604 as a result. Consequently, the printer unit 140 in the present embodiment adopts the smaller one of the size of the non-print area on the rear end side in the preceding sheet and the size of the non-print area on the front end side in the subsequent sheet as the overlap amount at the time of conveying each printing sheet as described above.

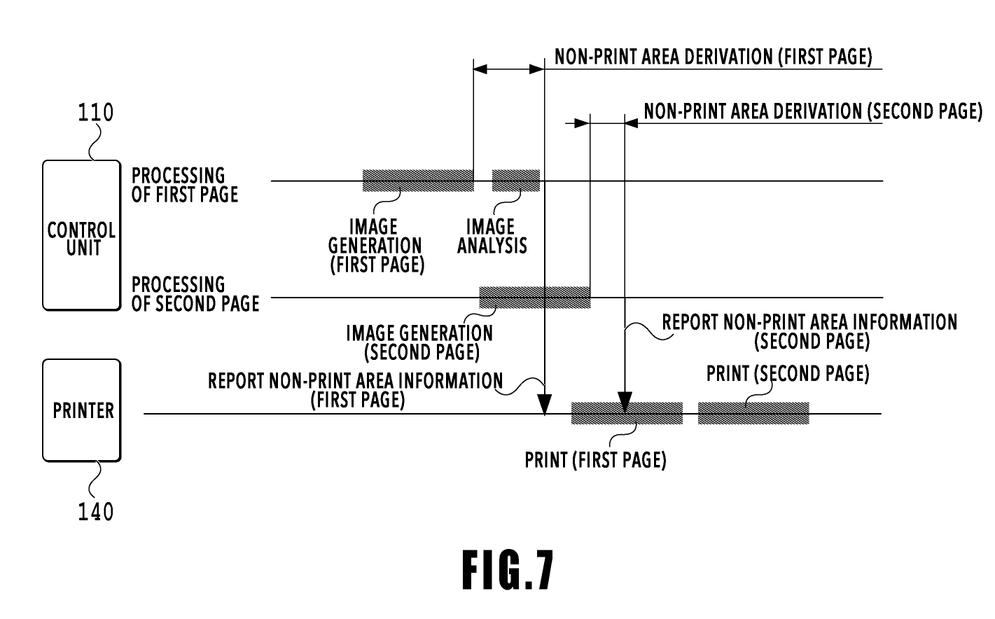

FIG. 7 is a diagram showing an example of a sequence in a case where a print job is input to the MFP 100. FIG. 7 shows an example in which s print job whose print target is document images corresponding to two pages and for which a 1 in 1 layout setting is set is input. In a case where the print job is input, the control unit 110 starts processing (image generation) of the first page and the second page in order. At the timing at which the image generation of the first page is completed, the control unit 110 performs the non-print area derivation processing shown in FIG. 5A and FIG. 5B and derives the size of the non-print area. In the example shown in FIG. 7, it is assumed that the image analysis at step S516 has been performed for the first page. Upon the completion of the non-print area derivation processing, the control unit 110 notifies the printer unit 140 of non-print area information. In the non-print area information, the value of the variable ret that is obtained finally by the non-print area derivation processing shown in FIG. 5A and FIG. 5B is stored. Similarly, the control unit 110 performs the non-print area derivation processing of the second page. In the example shown in FIG. 7, it is assumed that the image analysis at step S516 has not been performed for the second page. Upon the completion of the non-print area derivation processing of the second page, as in the case with the first page, the control unit 110 notifies the printer unit 140 of the non-print area information. Based on the notified non-print area information, the printer unit 140 (to be more specific, the controller 141) performs the sheet overlap control shown in FIG. 3A to FIG. 3D at the time of printing of the second page and conveys the printing sheet of the first page and the printing sheet of the second page with part of which overlapping each other.

As above, in the present embodiment, in the processing at steps S501 to S515 and S519, the variable ret indicating the size of the non-print area and the value derived or acquired based on the setting value of each function are compared and the variable ret is updated based on the comparison results. Then, the size of the non-print area is specified from the variable ret that is obtained finally. That is, the size of the non-print area is specified without performing the image analysis. Consequently, it is possible to reduce the printing time. Further, because the image analysis is not performed, it is possible to save the calculation resources, such as the CPU, and therefore, it is made possible to sufficiently allocate the calculation resources, such as the CPU, to other competitive operations performed in parallel to the printing processing.

Further, in the present embodiment, in a case where the variable ret obtained by performing updating based on the above-described comparison results is larger than the threshold value (in the present embodiment, the initial margin value of the printer unit 140), the image analysis is performed at step S516 and the final variable ret is derived. For example, there is a case where header information is printed within the area indicated by the bidirectional arrow 413, which is determined to be a non-print area from the print setting, in the layout image as shown in FIG. 4G However, even in such a case, it is made possible to specify the area before the area where header information is printed as a non-print area by performing the image analysis and deriving the final variable ret as described above.

Further, in the present embodiment, the variable ret is derived for both the front end side and the rear end side of the printing sheet and the derived variable ret on the front end side and the derived variable ret on the rear end side are sent to the printer unit 140. Then, one of the variable ret on the rear end side in the preceding sheet and the variable ret on the front end side in the subsequent sheet, which is smaller, is adopted as the overlap amount at the time of conveying each printing sheet. However, in a case where it is possible to normally fix a transferred image even in the state where two printing sheets overlap, it may also be possible to adopt one of the variable ret on the rear end side in the preceding sheet and the variable ret on the front end side in the subsequent sheet, which is larger, as the overlap amount at the time of conveying each printing sheet. That is, it may also be possible to adopt one of the values, which is selected in accordance with the method and performance of the printer unit 140, of the variable ret on the rear end side in the preceding sheet and the variable ret on the front end side in the subsequent sheet as the overlap amount at the time of conveying each printing sheet in an overlapping manner.

Further, in the present embodiment, as shown in FIG. 7, for each piece of printing processing for each printing sheet, the non-print area derivation processing shown in FIG. 5A and FIG. 5B is performed. For example, in a case where document images corresponding to six pages are printed with a 4 in 1 setting, the size of the non-print area is different between the first printing sheet on which document images corresponding to four pages are printed and the second printing sheet on which document images corresponding to two pages are printed. As described above, even in a case of receiving a print job in which arrangement of document images is different for each printing sheet, it is made possible to appropriately derive the overlap amount between each printing sheet by performing the non-print area derivation processing for each piece of printing processing for each printing sheet as shown in FIG. 7.

Further, in the present embodiment, the control unit 110 derives the sizes of the non-print areas on the front end side and on the rear end side of the printing sheet and delivers each derived value (variable ret) to the printer unit 140, and the printer unit 140 derives the overlap amount at the time of conveying each printing sheet based on those values. However, it may also be possible for the control unit 110 to derive the overlap amount at the time of conveying each printing sheet from the variable ret and to deliver information indicating the overlap amount (sheet overlap amount information) to the printer unit 140. Then, it may also be possible for the controller 141 to perform the sheet overlap control shown in FIG. 3 based on the sheet overlap amount information received from the control unit 110.

Further, in the present embodiment, the case is explained where the MFP including the scanner unit 130 is used as the image forming apparatus. However, it may also be possible to use, for example, an SFP (Single Function Peripheral) not including the scanner unit 130 as the image forming apparatus according to the present embodiment.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, it is possible to more securely reduce the printing time of printing processing to perform printing while conveying sheets in an overlapping manner.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-254098, filed Dec. 28, 2017, which is hereby incorporated by reference wherein in its entirety.

What is claimed is:

1. An image forming apparatus capable of conveying printing sheets in an overlapping manner to a printing unit, the image forming apparatus comprising:
an application unit configured to apply a print setting to an image;
a setting unit configured to set an overlap amount of one printing sheet and another printing sheet conveyed in a state of overlapping part of the one printing sheet based on the print setting; and
a conveyance unit configured to convey the one printing sheet on which an image after the print setting is applied by the application unit is printed and the other printing sheet in an overlapping manner in accordance with the overlap amount set by the setting unit.

2. The image forming apparatus according to claim 1, wherein
the setting unit:
specifies a length in a sub scanning direction of a non-print area continuous from an end portion in the sub scanning direction of a printing sheet based on the print setting; and
sets the specified length in the sub scanning direction of the non-print area as the overlap amount.

3. The image forming apparatus according to claim 2, wherein
the print setting is a setting for making effective a function by which printing is performed on the entire surface of a printing sheet,
the function by which printing is performed on the entire surface of the printing sheet includes a copy number print function and a background pattern print function, and
the setting unit sets, in a case where the function by which printing is performed on the entire surface of the printing sheet is effective, an initial margin value of the printing unit as the length in the sub scanning direction of the non-print area.

4. The image forming apparatus according to claim 2, wherein
the print setting includes image layout information indicating how images to be printed on a printing sheet are arranged on the printing sheet, and
the setting unit specifies the length in the sub scanning direction of the non-print area based on the image layout information.

5. The image forming apparatus according to claim 2, wherein
the print setting is a setting for making effective a combination function,
the combination function includes a stamp function, and
the setting unit specifies, in a case where the combination function is effective, a fixed value corresponding to the combination function as the length in the sub scanning direction of the non-print area.

6. The image forming apparatus according to claim 2, wherein
the print setting is a setting for making effective a function to print a specific pattern,
the specific pattern includes a test chart, and
the setting unit specifies, in a case where the function to print the specific pattern is effective, a fixed value corresponding to the specific pattern as the length in the sub scanning direction of the non-print area.

7. The image forming apparatus according to claim 2, wherein
the setting unit sets, in a case where a plurality of print settings is input, the smallest value of the lengths in the sub scanning direction of the non-print area specified by each of the plurality of print settings as the overlap amount.

8. The image forming apparatus according to claim 2, wherein
the setting unit analyzes, in a case where the overlap amount set based on the print setting is larger than a predetermined threshold value, image data for printing an image on each printing sheet and updates the overlap amount by the length in the sub scanning direction of the non-print area specified from the analysis results.

9. The image forming apparatus according to claim 8, wherein
as the predetermined threshold value, the initial margin value in the printing unit is set.

10. The image forming apparatus according to claim 2, wherein
the setting unit:
specifies the length in the sub scanning direction of the non-print area for each of a downstream side end portion and an upstream side end portion in the sub scanning direction of a printing sheet based on the print setting; and
sets one of the length in the sub scanning direction of the non-print area at the downstream side end portion and the length in the sub scanning direction of the non-print area at the upstream side end portion, which is smaller, as the overlap amount.

11. A control method in an image forming apparatus capable of conveying printing sheets in an overlapping manner to a printing unit, the method comprising the steps of:
applying a print setting to an image;
setting an overlap amount of one printing sheet and another printing sheet conveyed in a state of overlapping part of the one printing sheet based on the print setting; and
conveying the one printing sheet on which an image after the print setting is applied is printed and the other printing sheet in an overlapping manner in accordance with the set overlap amount.

12. A non-transitory computer readable storage medium storing a program for causing a computer to perform a control method in an image forming apparatus capable of conveying printing sheets in an overlapping manner to a printing unit, the method comprising the steps of:
applying a print setting to an image;
setting an overlap amount of one printing sheet and another printing sheet conveyed in a state of overlapping part of the one printing sheet based on the print setting; and
conveying the one printing sheet on which an image after the print setting is applied is printed and the other printing sheet in an overlapping manner in accordance with the set overlap amount.
